(19) United States
(12) Patent Application Publication
(10) Pub. No.: US 2015/0046507 A1
(43) Pub. Date: Feb. 12, 2015

(54) Secure Network Data

(71) Applicants: Vinay Saxena, Richardson, TX (US); Thomas Eaton Conklin, Leesburg, VA (US)

(72) Inventors: Vinay Saxena, Richardson, TX (US); Thomas Eaton Conklin, Leesburg, VA (US)

(73) Assignee: HEWLETT-PACKARD DEVELOPMENT COMPANY, L.P., Houston, TX (US)

(21) Appl. No.: 14/377,927

(22) PCT Filed: Aug. 30, 2012
(86) PCT No.: PCT/US2012/053122

§ 371 Date: Aug. 11, 2014

Related U.S. Application Data
(60) Provisional application No. 61/624,916, filed on Apr. 16, 2012.

(51) Int. Cl. H04L 29/08; H04L 29/06

(52) U.S. Cl. CPC H04L 67/10; H04L 63/20
USPC 709/201

(57) ABSTRACT

Disclosed herein are a system, non-transitofy computer readable medium, and method to secure network data. It is determined whether an application can execute in a first network based on information associated with the first network. The application is transferred to a second network, if it is determined that the application cannot execute in the first network. A secure connection is established between the application transferred to the second network and the data residing in the first network.

### CROSS REFERENCE TO RELATED APPLICATION

This application claims the benefit of U.S. Provisional Application No. 61/624,916, filed Apr. 16, 2012.

### BACKGROUND

“Cloud bursting” is a term used to describe the transfer of applications from a source network to a destination network due to the source network exhausting its resources. Such a transfer may also include the transfer of data, allowing all processing thereof to occur in the destination network. When the source network recovers, execution of the transferred applications may resume therein. In some instances the source network is a private network (“private cloud”) and the destination network is a public network (“public cloud”).

### BRIEF DESCRIPTION OF THE DRAWINGS

FIG. 1 is a block diagram of an example system that may be used to secure network data in accordance with aspects of the present disclosure.

FIG. 2 is a flow diagram of an example method in accordance with aspects of the present disclosure.

FIG. 3 is a working example in accordance with aspects of the present disclosure.

FIG. 4 is a further working example in accordance with aspects of the present disclosure.

### DETAILED DESCRIPTION

As noted above, when a cloud burst occurs, some applications and the data associated therewith are transferred to an external network where the data is processed until the source network recovers. However, access to the transferred data is often intended for users of the source network. Therefore, cloud bursts may result in copies of proprietary data being made in external networks where they may be accessed by users not authorized to view the data. Private cloud providers often burst into public clouds and copies of proprietary information behind. This problem is a concern for corporations or individuals contemplating a shift to cloud computing.

In view of the foregoing, disclosed herein are a system, non-transitory computer readable medium, and method to protect data in a network notwithstanding a cloud burst. In one example, it may be determined whether an application can execute in a first network based on information associated with the first network. In another example, the application may be transferred to a second network, if it is determined that the application cannot execute in the first network. In yet a further example, a secure connection may be established between the application transferred to the second network and the data residing in the first network. The system, non-transitory computer readable medium, and method disclosed herein permit an application to be transferred to an external network while keeping the data in the original network. Furthermore, the application may process the data remotely from the second network using a secure connection. As such, the techniques disclosed herein may prevent copies of proprietary data from being made in external networks, but still allow cloud bursts to occur when necessary. The aspects, features and advantages of the present disclosure will be appreciated when considered with reference to the following description of examples and accompanying figures. The following description does not limit the application; rather, the scope of the disclosure is defined by the appended claims and equivalents.

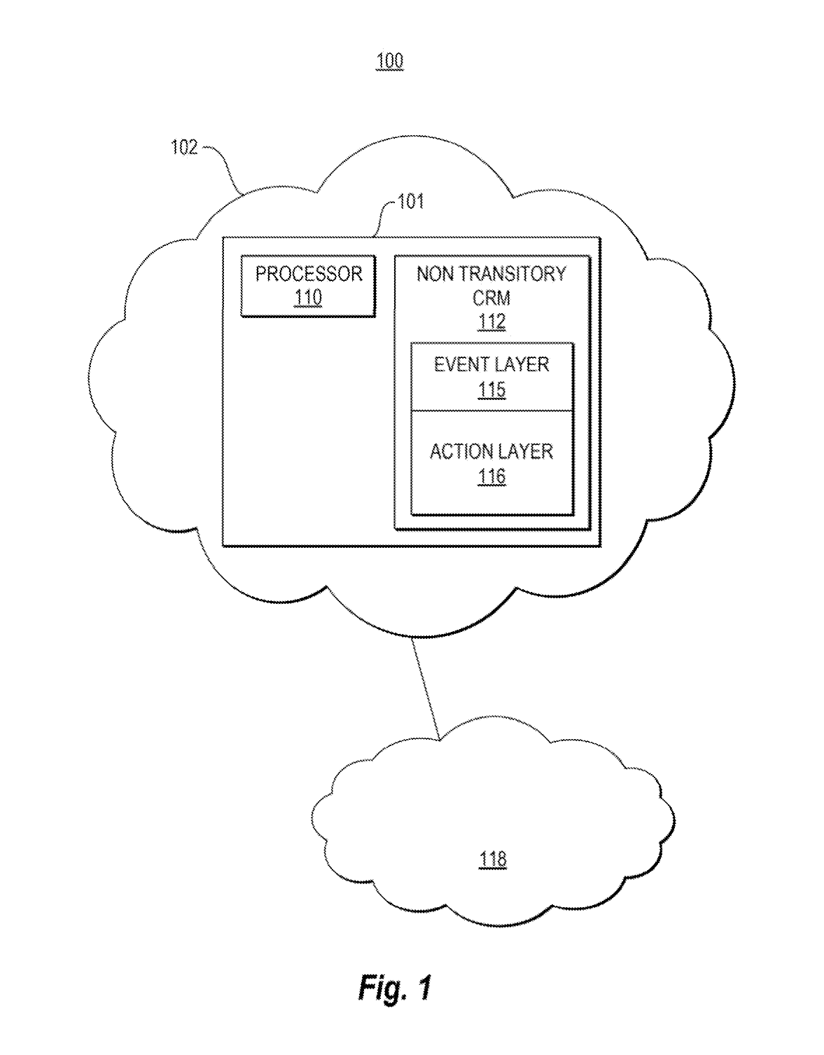

FIG. 1 presents a schematic diagram of an illustrative system 100 in accordance with aspects of the present disclosure. The computer apparatus 101 may include all the components normally used in connection with a computer. For example, it may have a keyboard and mouse and/or various other types of input devices such as pen-inputs, joysticks, buttons, touch screens, etc., as well as a display, which could include, for instance, a CRT, LCD, plasma screen monitor, TV, projector, etc. Computer apparatus 101 may also comprise a network interface (not shown) to communicate with other devices over a network.

The computer apparatus 101 may also contain a processor 110, which may be any number of well known processors, such as processors from Intel Corporation. In another example, processor 110 may be an application specific integrated circuit (“ASIC”). Non-transitory computer readable medium (“CRM”) 112 may store instructions that may be retrieved and executed by processor 110. The instructions may include an event layer 115 and an action layer 116. In one example, non-transitory CRM 112 may be used by or in connection with an instruction execution system other than computer apparatus 101 that can fetch or obtain the logic from non-transitory CRM 112 and execute the instructions contained therein. Non-transitory computer readable media may comprise any one of many physical media such as, for example, electronic, magnetic, optical, electromagnetic, or semiconductor media. More specific examples of suitable non-transitory computer-readable media include, but are not limited to, a portable magnetic computer diskette such as floppy diskettes or hard drives, a read-only memory (“ROM”), an erasable programmable read-only memory, a portable compact disc or other storage devices that may be coupled to computer apparatus 101 directly or indirectly. Alternatively, non-transitory CRM 112 may be a random access memory (“RAM”) device or may be divided into multiple memory segments organized as dual in-line memory modules (“DIMMs”). The non-transitory CRM 112 may also include any combination of one or more of the foregoing and/or other devices as well. While only one processor and one non-transitory CRM are shown FIG. 1, computer apparatus 101 may actually comprise additional processors and memories that may or may not be stored within the same physical housing or location.

Any intervening nodes of first network 102 and second network 118 may comprise various configurations and use various protocols including the Internet, World Wide Web, intranets, local Ethernet networks, private networks using communication protocols proprietary to one or more companies, cellular and wireless networks (e.g., Wi-Fi), instant messaging, HTTP and SMTP, and various combinations of the foregoing. Other networking examples will be discussed further below. Computer apparatus 101 may also comprise a plurality of computers, such as a load balancing network, that exchange information with different nodes of a network for the purpose of receiving processing, and transmitting data to multiple remote computers. In this instance, computer apparatus 101 may still be regarded as one node of the network. While only one node in first network 102 is shown for simplicity, it is understood that first network 102 and second network 118 may include any more interconnected computers.

The instructions residing in non-transitory CRM 112 may comprise any set of instructions to be executed directly (such as machine code) or indirectly (such as scripts) by processor 110. In this regard, the terms “instructions,” “scripts,” and “applications” may be used interchangeably herein. The computer executable instructions may be stored in any computer language or format, such as in object code or modules of source code. Furthermore, it is understood that the instructions may be implemented in the form of hardware, software, or a combination of hardware and software and that the examples herein are merely illustrative.

The instructions in event layer 115 may cause processor 110 to determine whether an application can execute in a first network based on information associated with the first network. Such information may comprise resources available in the first network. Resource availability may be based on a variety of real time network metrics. For example, the network metrics may comprise network traffic associated with the execution of network components, such as servers, processors, network switches, or virtual machines. The network traffic data may be collected, for example, using simple network management protocol (“SNMP”) and may obtain data pertaining to TCP connections, SWAP utilization, network utilization, etc. In a further example, power and thermal usage information may be collected. In yet a further example, data from hypervisor managers may be analyzed to determine the state of virtual machines executing in the network. Event layer 115 may store and compare the relevant data to individual threshold values.

In another example, the information associated with the first network may comprise policy decisions embodied in preconfigured business rules. The business rules may be preconfigured, for example, in an extended markup language (“XML”) file. In one example, a preconfigured business rule may provide that the network's power usage should be optimized. Thus, for instance, an application executing in first network 102 may be transferred to second network 118 when power consumption at first network 102 exceeds a predetermined threshold. When event layer 115 triggers a cloud burst, it may choose to transfer resources to a network based on geographic location. For example, if a cloud burst situation arises in a first network, the event layer may select a second network that is in proximity to the first network within a predetermined radius thereof.

Action layer 116 may transfer the application to a second network, if the application cannot execute in the first network and may secure communications between the transferred application and the data still residing in the first network. The secure communications may protect the data from being accessed by other applications in external networks. In one example, the first network may be a private network and the second network may be a public network. However, in a further example, both networks may be private networks.

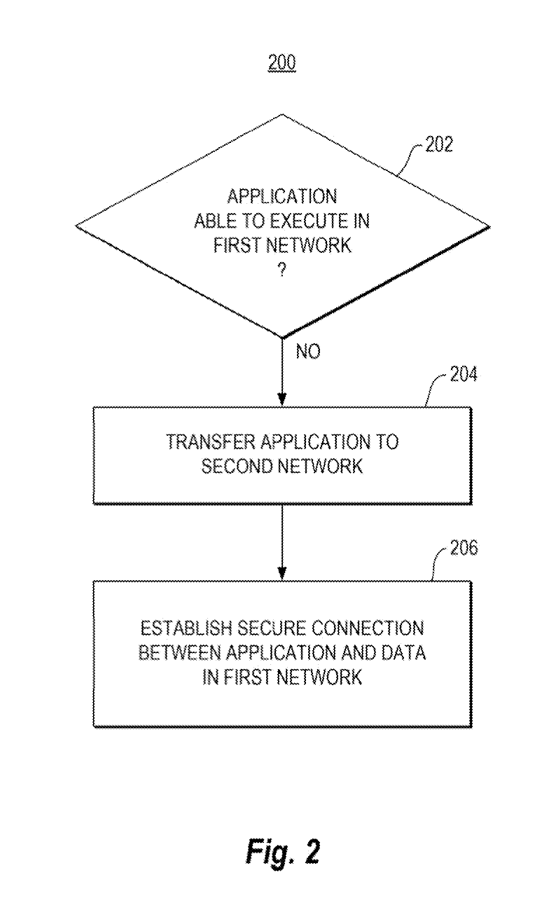

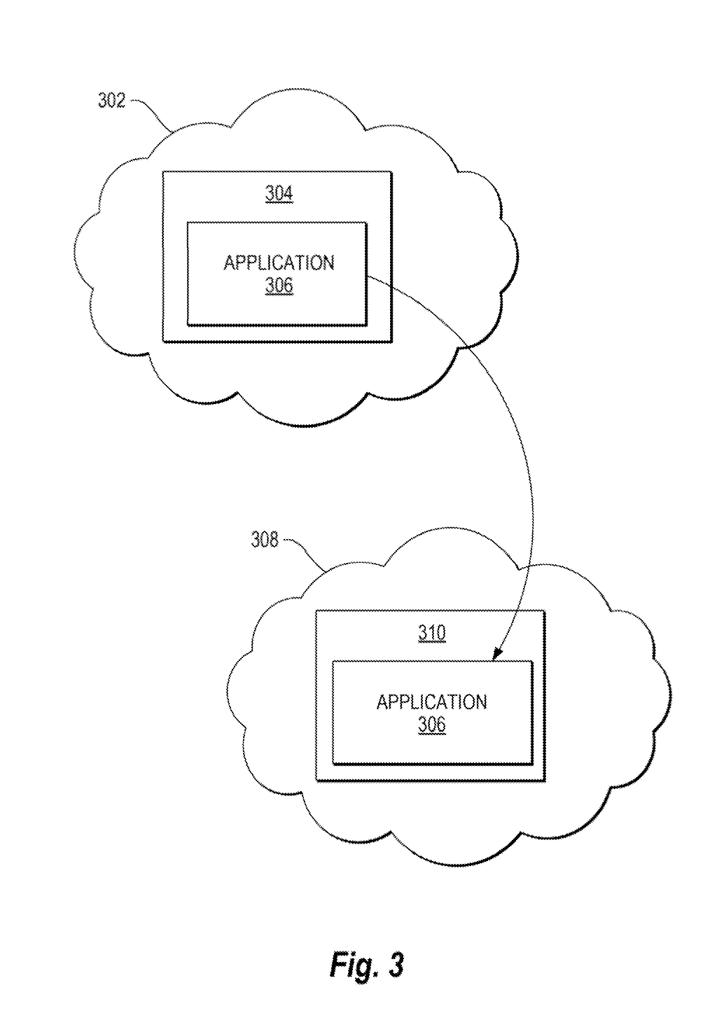

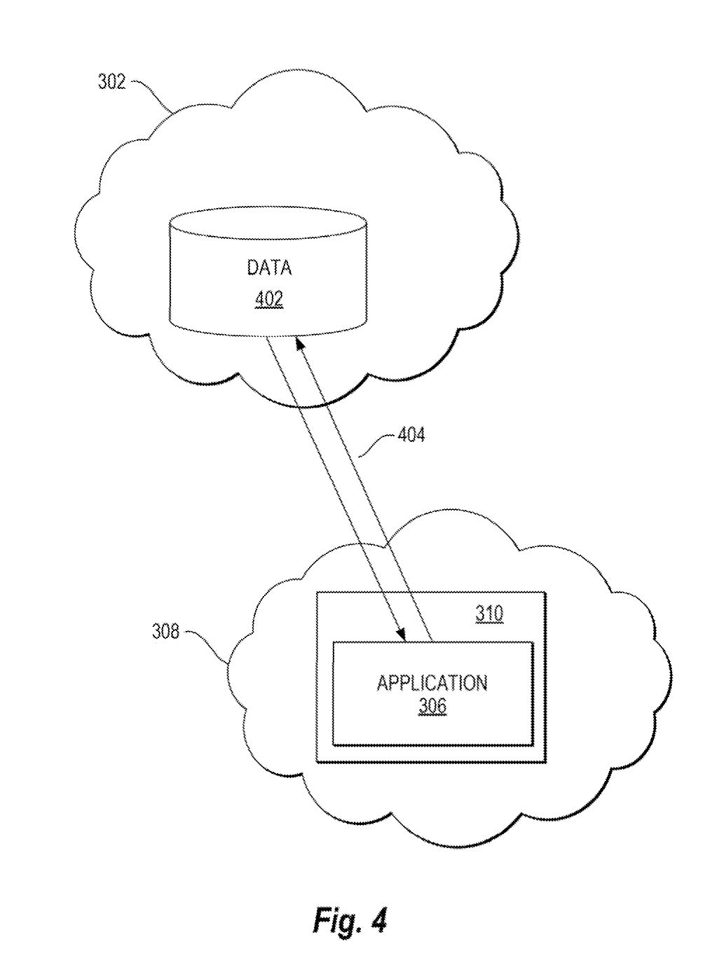

One working example of the system, method, and non-transitory computer-readable medium is shown in FIGS. 2-4. In particular, FIG. 2 illustrates a flow diagram of an example method 200 for securing network data in accordance with aspects of the present disclosure. FIGS. 3-4 show a working example in accordance with the techniques disclosed herein. The actions shown in FIGS. 3-4 will be discussed below with regard to the flow diagram of FIG. 2.

As shown in block 202 of FIG. 2, it may be determined whether an application is able to execute in a first network. Referring now to FIG. 3, a first network 302 and a second network 308 are shown. In this illustration, the first network 302 is a private network with applications and proprietary data of an entity. FIG. 3 also shows a computer apparatus 304 that may comprise components similar to those of computer apparatus 101 in FIG. 1. Application 306 may be an application originally intended to execute in computer apparatus 304 in first network 302. Second network 308 may be a backup network used to alleviate cloud burst situations in first network 302. In this example, second network 308 is a public network, such as is available from the Amazon™ Corporation, and may have a node or computer apparatus 310 also with components similar to those of computer apparatus 101 of FIG. 1. In one example, application 306 may be a virtual machine. In this instance, the cloud burst determination may be based on historical traffic trend data associated with VM resources and time of day (“TOD”).

Referring back to FIG. 2, if the application is not able to execute in the first network, the application may be transferred to the second network, as shown in block 204. Referring back to FIG. 3, the information associated with first network 302 may indicate that a cloud burst state has been reached and, in response thereto, application 306 may be transferred to computer apparatus 310 in second network 308. However, the data processed by application 306 may remain in first network 302.

Referring back to FIG. 2, a secure connection may be established between the application in the second network and the data in the first network, as shown in block 206. Referring now to FIG. 4, data 402 may be data processed by application 306 and may be stored in computer registers, in a relational database as a table having a plurality of different fields and records, XML documents or flat files. Data 402 may also be formatted in any computer-readable format and may comprise any information sufficient to identify the relevant information, such as numbers, descriptive text, proprietary codes, or information that is used by a function to calculate the relevant data. FIG. 4 shows a secure connection 404 established between application 306 and data 402.

Secure connection 404 may be implemented in a variety of ways. In one example, secure connection 404 may comprise “trunking” protocols that aggregate different layers of first network 302 and second network 308 to increase throughput. Such “trunking” may be implemented in layer 2 (i.e., the data link layer) of the open systems interconnected (“OSI”) model. The layer 2 trunk may be established between a port on a network switch in first network 302 and a port on a network switch in second network 308. “Trunking” may also occur in layer 3 (i.e., network layer) of the OSI model. Security at the layer 2 or layer 3 trunks may be established using virtual private networking (“VPN”) such that traffic between data 402 in first network 302 and application 306 in second network 305 may be isolated from other computers in second network 308. Security may also be provided using Internet protocol security (“IPSec”) for authenticating and encrypting each internet protocol (“IP”) packet transferred between data 402 and application 306.

In another example, secure connection 404 may comprise virtual local area networks (“VLAN”) between first network 302 and second network 308. VLAN identifiers may be established for use in communicating packets of data between the networks. Thus, packets of data from data 402 in first network 302 may be encapsulated with appropriate VLAN identifiers a id forwarded to application 306 in second network 305.

Advantageously, the foregoing system, method, and non-transitory computer readable medium secure data in cloud networks from unauthorized users notwithstanding cloud bursting scenarios arising therein. In this regard, cloud service providers may secure their customers data while maintaining quality of service. Furthermore, the techniques described herein may secure data from public or private cloud being delivered as over the top services. As such, users contemplating a switch to cloud services may be rest assured their data will be protected.

Although the disclosure herein as been described with reference to particular examples, it is to be understood that these examples are merely illustrative of the principles of the disclosure. It is therefore to be understood that numerous modifications may be made to the examples and that other arrangements may be devised without departing from the spirit and scope of the disclosure as defined by the appended claims. Furthermore, while particular processes are shown in a specific order in the appended drawings, such processes are not limited to any particular order unless such order is expressly set forth herein; rather, processes may be performed in a different order or concurrently and steps may be added or omitted.

1. A system comprising:
a first network containing an application and data to be processed by the application;
an event layer to determine whether the application execute in the first network based on information associated with the first network; and
an action layer to transfer the application to a second network if the application cannot execute in the first network and to secure communications between the transferred application and the data residing in the first network that is to be processed by the transferred application.

2. The system of claim 1, wherein the first network private network and the second network is a public network.

3. The system of claim 1 wherein the first network and the second network are both private networks.

4. The system of claim 1, wherein the information associated with the first network comprises resources available in the first network.

5. The system of claim 1, wherein the information associated with the first network comprises predetermined policy rules regarding the first network.

6. A non-transitory computer readable medium with instructions stored therein which, if executed, causes at least one processor to:
collect information associated with a first network;
determine whether an application is able to execute in the first network based on the information;
if the application is not able to execute in the first network:
transfer the application to a second network; and
establish a secure connection between the application transferred to the second network and data in the first network processed by the application such that the data in the first network is protected from access by other applications outside the first network.

7. The non-transitory computer readable medium of claim 6, wherein the first network is a private network and the second network is a public network.

8. The non-transitory computer readable medium of claim 6 wherein the first work and the second network are both private networks.

9. The non-transitory computer readable medium of claim 6, wherein the information associated with the first network comprises resources available in the first network.

10. The non-transitory computer readable medium of claim 6, wherein the information associated with the first network comprises predetermined policy rules regarding the first network.

11. A method comprising:
analyzing, using a processor, information associated with a first network;
determining, using the processor, whether an application is able to execute in the first network based on the information, the application having instructions therein to process data located in the first network;
if the application is not able to execute in the first network:
transferring, using the processor, the application to a second network; and
establishing, using the processor, secure connection between the application transferred to the second network and the data located in the first network such that the application can process the data while the data is protected from access by other applications outside the first network.

12. The method of claim 11, wherein the first network is a private network and the second network is a public network.

13. The method of claim 11 wherein the first network and the second network are both private networks.

14. The method of claim 11 wherein the information comprises resources available in the first network.

15. The method of claim 11 wherein the information associated with the first network comprises predetermined policy rules regarding the first network.
